(19) United States
(12) Patent Application Publication
(10) Pub. No.: US 2025/0033153 A1
(43) Pub. Date: Jan. 30, 2025

(54) MATERIAL REMOVAL MACHINES WITH MOVABLE TWO PIECE WORK TABLES

(71) Applicant: ILLINOIS TOOL WORKS INC., Glenview, IL (US)

(72) Inventors: Calvin States Nelson, Grayslake, IL (US); Timothy Patrick Weber, Vernon Hills, IL (US); Ruibin Zhang, Shanghai (CN); Jeffrey Robert Smith, Lake Bluff, IL (US); Roland Schaefer, Gurnee, IL (US)

(21) Appl. No.: 18/716,640

(22) PCT Filed: Dec. 10, 2021
(86) PCT No.: PCT/CN2021/137035

§ 371 Date: Jun. 5, 2024

(51) Int. Cl. B23Q 1/44; B23Q 1/03; B24B 41/06

(52) U.S. Cl. CPC B23Q 1/44; B23Q 1/037; B24B 41/068

(57) ABSTRACT

Described herein are examples of material removal machines with work tables separated by an air gap. In some examples. the air gap may provide space for a material removal tool of the material removal machine to extend between and substantially below the work tables to effect a deep cut on a workpiece that extends across the air gap. In some examples. a table actuator may be configured to move the work tables in tandem, allowing for the work tables and/or work piece to be moved to the material removal tool, rather than vice versa. Efficient design of the work tables and material removal machine ensures that the air gap between the work tables remains unobstructed all the way to a floor of the material removal machine. and ensures that the space underneath the work tables is sufficient for fluid/debris drainage and operator access.

### TECHNICAL FIELD

The present disclosure generally relates to material removal machines and, more particularly, to material removable machines with movable two piece work tables.

### BACKGROUND

Material removal tools are sometimes used to remove material from a workpiece, such as, for example, to produce a desired shape and/or obtain a smaller sample from a larger workpiece. Conventional material removal tools (e.g., saws, grinders, and/or polishers) are either stationary or configured to be moved and/or manipulated by human hands. Some of the more modern material removal machines have material removal tools configured for movement and/or manipulation via automated machine assemblies.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to material removable machines with movable two piece work tables, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIGS. 1a-1d show front perspective, front, cross-sectional, and rear perspective views, respectively, of an example material removal machine, in accordance with aspects of this disclosure.

FIGS. 2a-2d show upper perspective, lower perspective, top, and bottom, views of an example table assembly of the material removal machine of FIGS. 1a-1d, in accordance with aspects of this disclosure.

FIG. 3 shows a front view of the example table assembly of FIGS. 2a-2d with a table actuator omitted, in accordance with aspects of this disclosure.

FIGS. 4a-4b show examples of an alternative table assembly with the table actuator omitted, in accordance with aspects of this disclosure.

The figures are not necessarily to scale. Where appropriate, the same or similar reference numerals are used in the figures to refer to similar or identical elements. For example, reference numerals utilizing lettering (e.g., work table 202a, work table 202b) refer to instances of the same reference numeral that does not have the lettering (e.g., work tables 202).

### DETAILED DESCRIPTION

Some examples of the present disclosure relate to material removal machines with two work tables separated by an air gap for deep cuts. In some examples, the air gap allows a material removal tool of the material removal machine to move between and substantially below the work table(s) to effect a deep cut on a workpiece that extends across the gap.

While some material removal machines have a single work table with space off an edge of the work table for deep cuts, such machines only allow the workpiece to be secured on one side of the cut. This can lead to flexing/bending of the workpiece, undue stress on the work table, and/or other detrimental effects. In contrast, the two separated work tables of the material removal machines disclosed herein allow the workpiece to be secured to (and/or supported by) a work table on both sides of a deep cut.

Though some machines use vising/clamping grooves in the work table for deep cuts, these grooves tend to be relatively shallow, and often require that the vise(s) raise the workpiece above the table. Additionally, the height of the material removal tool must be precisely controlled to prevent damage to the work table. While deeper grooves in the work table(s) provide more room, they also tend to result in work tables that are thicker, heavier, and harder to move. Such work tables in turn result in heavier machines that incur more power and stress when actuating, while leaving less space under the work table for operator access and/or to flush out debris.

The material removal machines of the present disclosure provide an air gap between work tables that allows for deeper cuts than a table groove. This eliminates the need for special vising and/or precision planning. Additionally, by enabling coordinated movement of the work tables in one axis, and movement of the material removal tool along (and about) a second perpendicular axis, a more compact and versatile material removal machine can be provided. With this design, the material removal machine leaves plenty of space under the work table for operator access and/or to flush out debris.

Some examples of the present disclosure relate to a material removal machine, comprising: a material removal tool; a tool support assembly retaining the material removal tool, the tool support assembly configured to translate the material removal tool along a first axis; a first work surface; a second work surface separated from the first work surface by an air gap; a surface actuator configured to move the first work surface and second work surface along a second axis that is perpendicular to the first axis, such that the first work surface and second work surface can be moved to position the material removal tool in the air gap between the first work surface and second work surface when the material removal tool is aligned with the air gap; a first surface support configured to support the first work surface; and a second surface support configured to support the second work surface, the air gap extending from a top of the first work surface or second work surface to a first bottom of the first surface support and a second bottom of the second surface support along a third axis that is perpendicular to the first axis and second axis, such that there is nothing obstructing the material removal tool from moving in the air gap between the first work surface and first surface support, and the second work surface and the second surface support.

In some examples, the material removal tool comprises a cutting, sectioning, or grinding disc. In some examples, each of the first work surface and second work surface comprises a work table having a plurality of trenches configured to receive a vise that is configured to retain a sample. In some examples, the material removal machine further comprises a coupler connecting the surface actuator to the first work surface or second work surface, the surface actuator being configured to move the first work surface and second work surface via the coupler.

In some examples, the coupler connects to the first work surface and the second work surface. In some examples, the first work surface comprises a first rear end, a first front end, and a first middle halfway between the first rear end and the first front end, the second work surface comprises a second rear end, a second front end, and a second middle halfway between the second rear end and the second front end, the second rear end, second front end, and second middle of the second work surface are approximately aligned with the first rear end, first front end, and first middle, respectively, of the first work surface, and the second rear end and second middle of the second work surface is separated from the first rear end and first middle of the first work surface by the air gap. In some examples, the material removal machine further comprises a first support guide configured to guide the first work surface along the second axis when moved by the surface actuator, the first surface support coupling the first work surface to the first support guide; and a second support guide configured to guide the second work surface along the second axis when moved by the surface actuator, the second surface support coupling the second work surface to the second support guide, the air gap extending from the top of the first work surface or second work surface to a first support guide bottom of the first support guide and a second support guide bottom of the second support guide along a third axis.

In some examples, the first surface support comprises a first bearing assembly allowing the first surface support to move along the first support guide, and the second surface support comprises a second bearing assembly allowing the second surface support to move along the second support guide, the surface actuator being configured to move the first work surface, first surface support, second work surface, and second surface support. In some examples, the material removal machine further comprises a cabinet having a chamber that encloses the material removal tool, tool support assembly, first work surface, second work surface, surface actuator, first surface support, second surface support, and air gap. In some examples, the first support and second support retain the first work surface and second work surface above a floor of the chamber, the air gap extending from the floor of the chamber to the top of the first work surface or second work surface along the third axis, such that there is nothing below the top of the first work surface or second surface obstructing the material removal tool from being positioned in the air gap.

Some examples of the present disclosure relate to a material removal machine, comprising: a material removal tool; a tool support assembly retaining the material removal tool, the tool support assembly configured to translate the material removal tool along a first axis; a first work table; a second work table separated from the first work table by an air gap; a surface actuator configured to move the first work surface and second work surface along a second axis that is perpendicular to the first axis, such that the first work surface and second work surface can be moved to position the material removal tool in the air gap between the first work surface and second work surface when the material removal tool is aligned with the air gap; and a support guide configured to guide movement of the first work surface or the second work surface along the second axis when moved by the table surface, the air gap extending from a top of the first work surface or second work surface to a bottom of the support guide along a third axis that is perpendicular to the first axis and second axis, such that there is nothing obstructing the material removal tool from moving in the air gap between the first work surface and the second work surface.

In some examples, wherein the material removal tool comprises a cutting, sectioning, or grinding disc. In some examples, each of the first work surface and second work surface comprises a work table having a plurality of trenches configured to receive a vise that is configured to retain a sample. In some examples, the material removal machine further comprises a coupler connecting the surface actuator to the first work surface or second work surface, the surface actuator being configured to move the first work surface and second work surface via the coupler.

In some examples, the coupler connects to the first work surface and the second work surface. In some examples, the first work surface comprises a first rear end, a first front end, and a first middle halfway between the first rear end and the first front end, the second work surface comprises a second rear end, a second front end, and a second middle halfway between the second rear end and the second front end, the second rear end, second front end, and second middle of the second work surface are approximately aligned with the first rear end, first front end, and first middle, respectively, of the first work surface, and the second rear end and second middle of the second work surface is separated from the first rear end and first middle of the first work surface by the air gap. In some examples, the support guide comprises a first support guide configured to guide movement of the first work surface along the second axis when moved by the surface actuator, the material removal machine further comprising a second support guide configured to guide movement of the second work surface along the second axis when moved by the surface actuator, the second surface support coupling the second work surface to the second support guide, a first surface support configured to support the first work surface, the first surface support coupling the first work surface to the first support guide; and a second surface support configured to support the second work surface, the second surface support coupling the second work surface to the second support guide, the air gap extending from the top of the first work surface or second work surface to a first bottom of the first surface support and a second bottom of the second surface support along the third axis.

In some examples, the first surface support comprises a first bearing assembly allowing the first surface support to move along the first support guide, and the second surface support comprises a second bearing assembly allowing the second surface support to move along the second support guide, the surface actuator being configured to move the first work surface, first surface support, second work surface, and second surface support. In some examples,, the material removal machine further comprises a cabinet having a chamber that encloses the material removal tool, tool support assembly, first work surface, second work surface, surface actuator, support guide, and air gap. In some examples, the first work surface and second work surface are retained above a floor of the chamber, the air gap extending from the floor of the chamber to the top of the first work surface or second work surface along the third axis, such that there is nothing below the top of the first work surface or second surface obstructing the material removal tool from being positioned in the air gap.

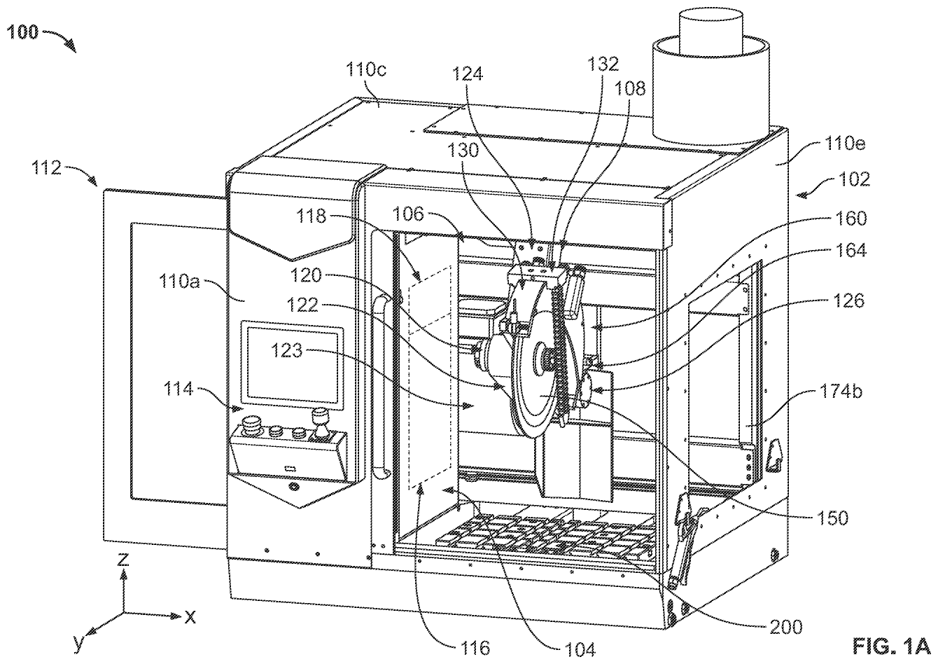

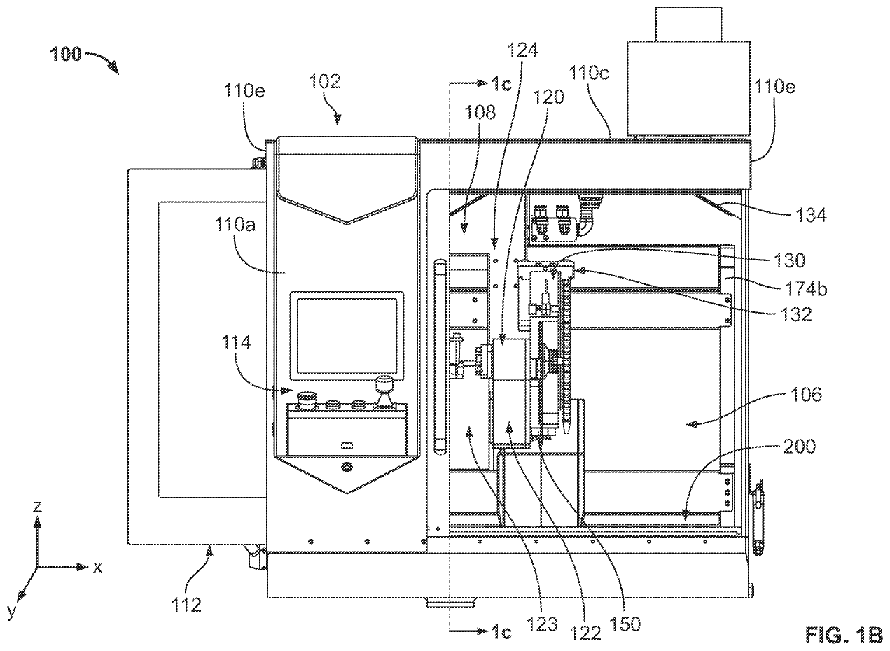

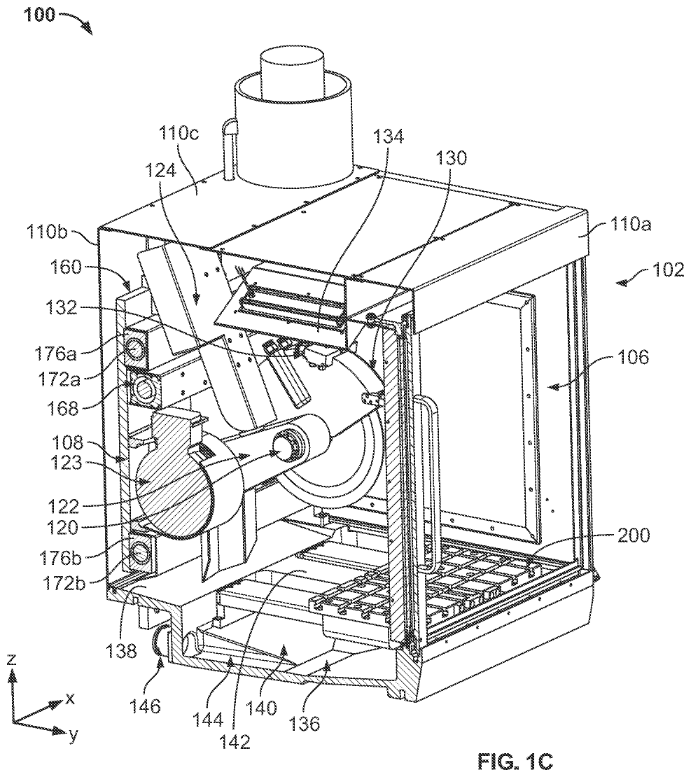

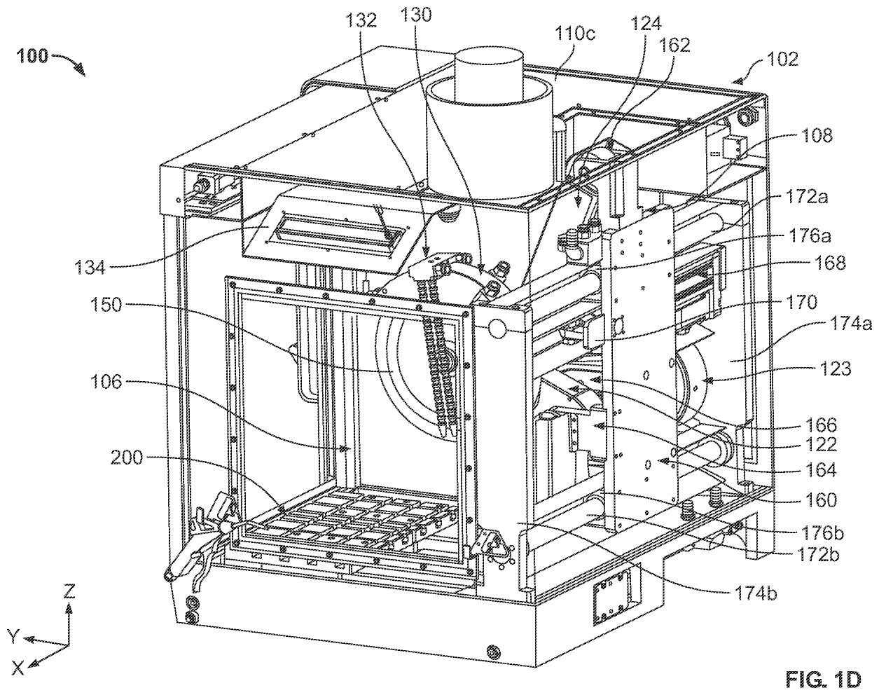

FIGS. 1a-1d show views of an example material removal machine 100. As shown, the material removal machine 100 includes a cabinet 102 enclosing an electrical box 104, a cutting chamber 106, a material removal tool 150, a tool support assembly 108, and a table assembly 200. In the examples of FIGS. 1a-1d, the cabinet 102 has an approximately rectangular prism shape, with a front wall 110a, rear wall 110b, top wall 110c, bottom wall 110d, and two sidewalls 110e. The cabinet 102 includes a door 112 that opens and closes access to the cutting chamber 106 via the front wall 110. Windows formed in the side walls 110e and the front door 112 allow a user to see within the cutting chamber 106. While shown as a sliding door 112 in the examples of FIGS. 1a-1d, in some examples, the door 112 may be a different style (e.g., hinged, garage, etc.).

In the examples of FIGS. 1a-1d, the cabinet 102 further includes a user interface (UI) 114 on the front wall of cabinet 102 (though, in some examples, the UI 114 may be located elsewhere). As shown, the UI 114 includes several user accessible inputs and outputs. In some examples, the outputs include one or more visual outputs (e.g., touch display screens, video monitors, light emitting diodes, incandescent lights, and/or other lights, etc.) and/or one or more audio outputs (e.g., audio speakers). In some examples, the inputs include one or more visual inputs (e.g., touch display screens), haptic inputs (e.g., buttons, knobs, switches, etc.), and/or one or more audio inputs (e.g., microphones). In some examples, the UI 114 may be used by an operator to directly control the material removal machine 100, and/or configure a program to control the material removal machine 100.

In some examples, the UI 114 is in electrical communication with control circuitry 116 and a power supply 118 of the material removal machine 100. As shown in FIG. 1a, the control circuitry 116 and power supply 118 are retained within the electrical box 104 of the material removal machine 100 (though, in some examples, they may be located elsewhere).

In some examples, the control circuitry 116 is connected to (and/or in electrical communication with) the various actuators of the tool support assembly 108 and/or table assembly 200, further discussed below. In some examples, the control circuitry includes memory circuitry (e.g., configured to store one or more programs, parameters, etc.) and/or processing circuitry (e.g., configured to execute one or more programs). In some examples, the control circuitry 116 is configured to receive one or more input signals from the UI 114 and/or the various actuators of the tool support assembly 108 and/or table assembly 200. For example, the control circuitry 116 may receive one or more signals from the UI 114 representative of one or more material removal operations, and/or parameters for the operation(s). As another example, the control circuitry 116 may receive one or more signals from the actuator(s) representative of a current status and/or position of the actuator(s).

In some examples, the control circuitry 116 is further configured to output one or more control (and/or command) signals to the UI 114 and/or the various actuators of the tool support assembly 108 and/or table assembly 200. For example, the control circuitry 116 may output one or more signals to the UI 114 representative of the current status and/or position of the actuator(s), tool support assembly 108, and/or table assembly 200. As another example, the control circuitry 116 may output one or more signals to the actuators representative of a command to change their status/position, and/or to actuate/move the tool support assembly 108, and/or table assembly 200.

In some examples, the power supply 118 is connected to (and/or in electrical communication with) the UI 114, control circuitry 116, and/or the actuators of the tool support assembly 108 and/or table assembly 200. In some examples, the UI 114, control circuitry 116, and/or the actuators may include one or more power sources configured to provide power to themselves. In some examples, the control circuitry 116 (and/or other controllers of the material removal machine 100) may direct power to the one or more actuators of the tool support assembly 108 and/or table assembly 200 as appropriate.

In the example of FIGS. 1a-1d, the material removal tool 150 is retained within the cutting chamber 106 in a raised position above the table assembly 200 by the tool support assembly 108. As shown, the material removal tool 150 is disc shaped. In some examples, the material removal tool 150 may be a cutting, sectioning, and/or grinding wheel.

In the examples of FIGS. 1a-1d, the tool support assembly 108 includes a spindle assembly 120 that retains the material removal tool 150 in such a way that the material removal tool 150 may be rotated about an axis defined by the spindle assembly 120 (and/or a spindle of the spindle assembly). As shown, the axis defined by the spindle assembly 120 (and/or spindle) is parallel to the x axis.

In the examples of FIGS. 1a-1d, the tool support assembly 108 further includes an armature 122 connected to the spindle assembly 120. In some examples, the armature 122 houses a belt and pulley system configured to rotate the spindle of the spindle assembly 120, and thereby rotate the material removal tool 150. As shown, the armature 122 is connected to a motor 123 of the tool support assembly 108. In some examples, the motor 123 is configured to actuate the belt and pulley system housed by the armature 122, which, in turn, actuates the spindle assembly 120.

In the example of FIGS. 1a-1d, the armature 122 is also connected to a rotational actuator 124 of the tool support assembly 108. In some examples, the rotational actuator 124 is a linear actuator configured to push forwards and downwards (e.g., in the y and z directions) on the armature 122, so as to rotate the armature 122 (and spindle assembly 120 and material removal machine 100) about a joint 126. In some examples, the rotational actuator 124 may instead translate (rather than rotate) the material removal tool 150 (e.g., in the z direction).

In the examples of FIGS. 1a-1d, the armature 122, rotational actuator 124, and motor 123 connect to a sled 160 of the tool support assembly 108. FIG. 1d shows the machine 100 with portions of the rear wall 110b, top wall 110c, and sidewall 110e made transparent. As best seen in FIG. 1d, the sled 160 is a generally thin rectangular component that extends upwards along the rear wall 110b of the cabinet 102. At the top of the sled 160 is a sled joint 162 that connects the sled 160 to the rotational actuator 124. Farther down the sled 160 is a joint bracket 164 that connects the armature 122 to the sled 160 at the joint 126. As shown, a motor bracket 166 connects the motor 123 to the sled 160 on the other side of the armature 122 from the joint bracket 164. In some examples, the attachment of the armature 122, rotational actuator 124, and motor 123 to the sled 160 allows for the motor 123, rotational actuator 124, and armature 122 (as well as the spindle assembly 120 and/or material removal tool 150 attached to the armature 122) to be moved with the sled 160.

In some examples, the sled 160 is configured to be moved via a translational actuator 168. In some examples, the translational actuator 168 is a linear actuator configured to extend and/or retract an actuator arm. As best seen in FIG. 1d, the translational actuator 168 attaches its actuator arm to the sled 160 at an actuator bracket 170. In some examples, the translational actuator is configured to move the sled 160 along an axis defined by the translational actuator 168 (e.g., along and/or parallel to the x axis) via movement of its actuator arm and the attachment of its actuator arm to the sled 160 at the actuator bracket 170.

As shown in FIG. 1d, rail guides 172 are positioned above and below the translational actuator 168. The rail guides 172 connect to and/or extend between two pillars 174. Each pillar 174 is positioned near the rear wall 110b; proximate to, and slightly inwards of, a sidewall 110e. The sled 160 has sleeves 176 that encircle portions of each rail guide 172. In some examples, each sleeve 176 may include a bearing assembly allowing the sleeve 176 to slide along the rail guide 172. As shown, the rail guides 172 extend parallel to one another and to the translational actuator 168 (e.g., along and/or parallel to the x axis). In some examples, the rail guides 172 support the sled 160 and guide the sled 160 back and forth between the pillars 174 when moved by the translational actuator 168.

In the example of FIG. 1d, the translational actuator 168 and rail guides 172 are disposed within protective casings. In some examples, the casings help to shield the translational actuator 168 and rail guides 172 from debris, particulates, coolant, and/or other matter within the cutting chamber 106. While not shown in the figures, in some examples, the translational actuator 168 may also include means for translating the material removal tool 150 in one or more other axes (e.g., the y and/or z axis).

In the examples of FIGS. 1a-1d, the tool support assembly 108 further includes a shield 130 that partially covers an upper portion of the material removal tool 150. As shown, the shield 130 is connected to the armature 122 at the spindle assembly 120, and connected to the linear actuator 128 at the joint 126. In this way, the shield 130 is both rotated and translated with the material removal tool 150.

In the examples of FIGS. 1a-1d, a spray nozzle assembly 132 is attached to the shield 130. As shown, the spray nozzle assembly 132 includes two spray nozzles on one side of the shield 130. In some examples, the spray nozzle 132 may include more or fewer nozzles on one or both sides of the shield 130. In some examples, the spray nozzle assembly 132 is configured to rotate and translate with the shield 130. In some examples, the spray nozzle assembly 132 has inlets configured to connect with a fluid reservoir (e.g., of a recirculation system—not shown). In some examples, the spray nozzle assembly 132 is configured to spray fluid (e.g., via the spray nozzles) within the cutting chamber 106, to help cool the components of the material removal machine 100 and/or flush debris out of the cutting chamber 106.

In the examples of FIGS. 1a-1d, the cutting chamber 106 is bounded by a ceiling 134, a floor 136, the front door 112, the electrical box 104, the rear wall of the cabinet 102, and the side walls 110e of the cabinet 102. As shown, at least part of the ceiling 134 is below the top wall 110 of the cabinet 102. In some examples, other boundaries of the cutting chamber 106 may also be spaced from the walls 110 of the cabinet 102. Portions of the floor 136 of the cutting chamber, for example, are spaced above the bottom wall 110 of the cabinet 102.

As shown in FIG. 1c, the floor 136 forms an inclined ledge 138 at the rear of the cutting chamber 106. The inclined ledge 138 extends from the rear of the cutting chamber 106 and drops off into a tray 140 that is approximately (e.g., within 0-10 cm error) aligned on one side with an edge of the electrical box 104. As shown, the tray 140 retains the table assembly 200, while also collecting and draining fluid and debris.

In the example of FIG. 1c, a floor beam 142 approximately bisects the tray 140, separating the tray 140 into two portions. As shown, the floor beam 142 extends from the inclined ledge 138 approximately (e.g., within 0-10 cm error) halfway to the front of the recessed tray 140. In some examples, the floor beam 142 is configured to cover and/or protect portions of the table assembly 200.

In the example of FIG. 1c, the floor 136 is inclined at the front and rear ends of the tray 140 on either side of the floor beam 142, to form a basin into which fluid and/or debris can flow and/or collect. As shown in FIG. 1c, the floor 136 further forms an outlet channel 144 at a side edge of the recessed floor 136 that leads to an outlet pipe 146, to allow the fluid and/or debris to flow out of the basin. In some examples, the outlet pipe 146 may be in fluid communication with a fluid recirculation system (not shown).

In the example of FIG. 1c, the table assembly 200 is retained within the tray 140 at the floor 136 of the cutting chamber 106. In some examples, the upper ends of the inclines have recesses configured to receive stands 214 of the table assembly 200 (further discussed below), such that the table assembly 200 is raised above the fluid/debris collecting basin and/or outlet channel 144. Sufficient space remains between the table assembly 200 and the floor 136 to allow fluid/debris to collect in the basin, and/or allow space for operator access. As shown in FIG. 1b, a top of the table assembly 200 is approximately (e.g., within 0-10 cm error) aligned with a lower edge of the front door 112.

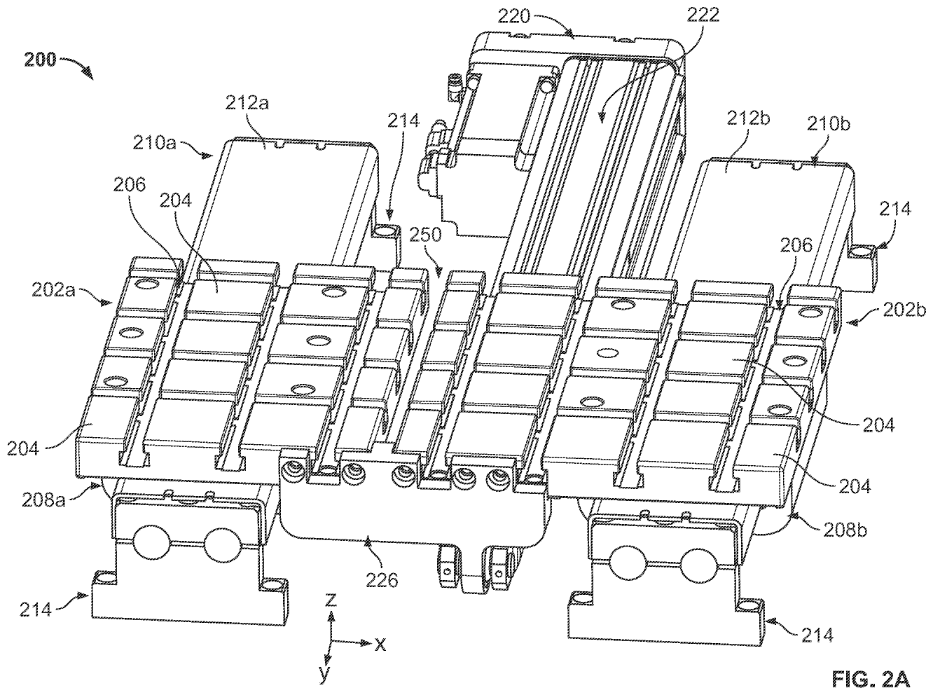

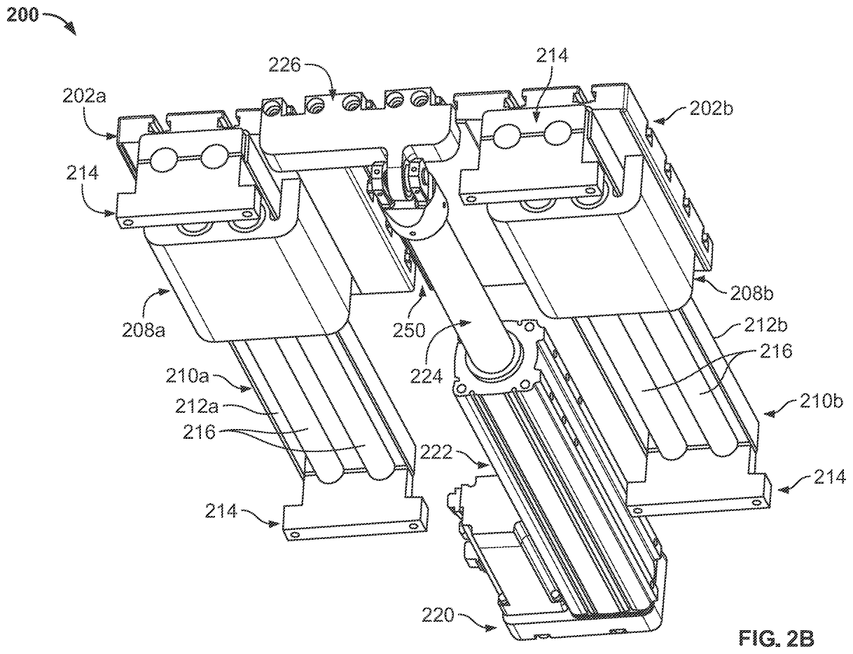

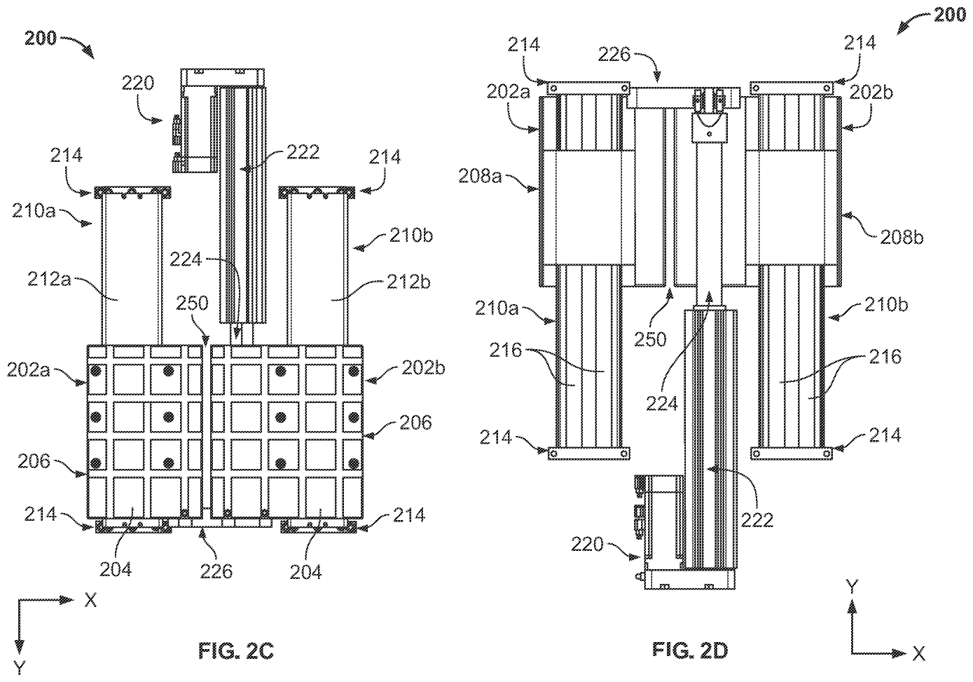

FIGS. 2a-2d depict the table assembly 200 removed from the cutting chamber 106. As shown, the table assembly 200 includes a first work table 202a and a second work table 202b. Each work table 202 is an approximately rectangular surface. The front and rear edges of the first work table 202a are approximately (e.g., within 0-10 cm error) aligned with the front and rear edges, respectively, of the second work table 202b (e.g., along an axis parallel to the x axis).

In the examples of FIGS. 2a-2d, each work table 202 is formed into a grid of raised platforms 204 separated by trenches 206 that crisscross the work table 202. Some of the platforms 204 additionally include holes configured to receive fasteners (e.g., screws, bolts, etc.). In some examples, the trenches 206, platforms 204, and/or holes may be used to secure retaining clamps and/or vises to the work table 202.

In some examples, the clamps and/or vises may, in turn, secure workpieces to the work tables 202. In some examples, the workpieces may be instead directly supported by the work table(s) 202, rather than indirectly through a clamp/vise. While described as tables 202, in some examples, the work tables 202 may comprise some other surface configured to support one or more workpieces within the cutting chamber.

In the examples of FIGS. 2a-2d, each work table 202 is supported by a table support 208. Each table support 208 is coupled to a work table 202, and extends around a support guide 210. In some examples, each support guide 210 is configured to guide a work table 202 along a path defined by the support guide 210.

In the examples of FIGS. 2a-2d, each support guide 210 comprises a U shaped support beam 212 and two guide rails 216. As shown, the support beam 212 covers and/or protects the two guide rails 216, which are positioned within a channel of the support beam 212. Each table support 208 encircles a portion of the two guide rails 216 and, in some examples, includes a bearing assembly that allows the table support 208 to slide along the guide rails 216.

In the examples of FIGS. 2a-2d, each support beam 212 and each guide rail 216 extends between, and is coupled to, two support stands 214. In some examples, the support stands 214 are configured to sit in complementary recesses in the floor 136 of the tray 140 and/or be secured to the floor 136 of the tray 140 by fasteners. When so secured, the support stands 214 support the support guides 210, table supports 208, and work tables 202 above the floor 136 of the cutting chamber 106.

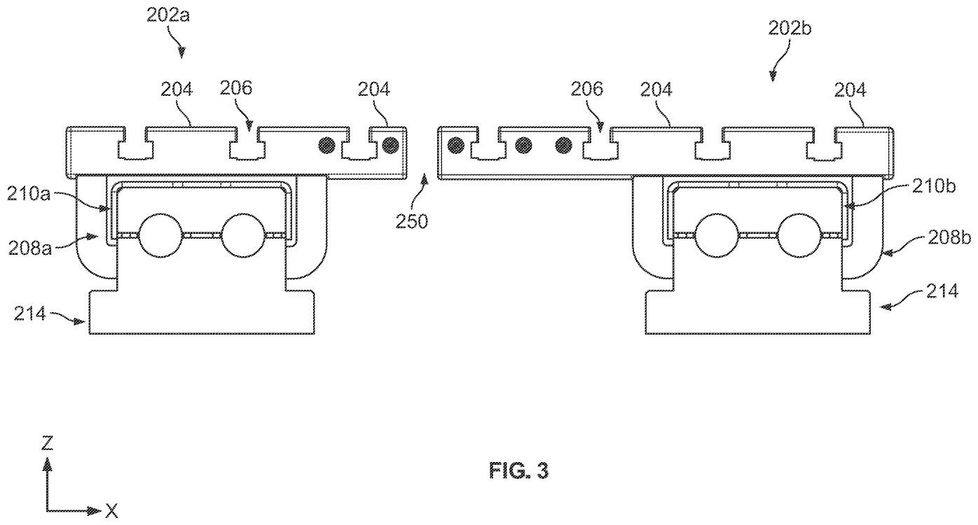

In the examples of FIGS. 2a-2d, the first work table 202a is separated from the second work table 202b by an air gap 250. In some examples, the air gap 250 (and/or the distance between the work tables) is wider than the width of the material removal tool 150, such that the material removal tool 150 can be moved into and/or positioned in the air gap between the two work tables 202. As shown in FIG. 3, the air gap 250 extends from a top of each work table 202 down to below both support guides 210 and table supports 208. In some examples, the air gap 250 extends all the way to the floor 136 of the tray 140. In some examples, the air gap 250 may provide ample space for the material removal tool 150 to extend below the work tables 202 to accomplish a deep cut on a workpiece.

In the examples of FIGS. 2a-2d, the table assembly 200 further includes a table actuator 220 configured to move the work tables 202 (and/or a workpiece secured to the work table(s) 202) along the support guides 210. As shown, the table actuator 220 includes an actuator rod 222 configured for reciprocal movement in and out of an actuator housing 224. In some examples, the actuator rod is configured for movement along an axis defined by the actuation rod (e.g., parallel to the y axis). Notably, the actuator rod 222 and actuator housing 224 are offset from (and/or out of alignment with) the air gap 250 along the length of the support guides 210, so that neither will obstruct the material removal tool 150 from operating in the air gap 250.

In the examples of FIGS. 2a-2d, the actuator rod 222 is connected to both work tables 202 via an actuator coupler 226. As shown, a first end of the actuator coupler 226 is hingedly connected to an end of the actuator rod 222, while an opposite end of the actuator coupler 226 is secured to the front ends of the work tables 202. In some examples, the coupler 226 may is secured to the work tables 202 via one or more fasteners. Though the actuator coupler 226 does bridge the air gap 250 between the two work tables 202, it does so at the front ends of the work tables 202, increasing (e.g., maximizing) the available length of the air gap 250 (e.g., along the y axis).

In some examples, the table actuator 220 is configured to move (and/or actuate) the table in response to receiving appropriate power from the power supply 118 and/or one or more control signals from the control circuitry 116. During actuation, the actuator rod 222 moves back and forth, pushing and/or pulling the work tables 202 (and/or any workpiece supported on the work tables 202) with it via the coupler 226. When being moved by the table actuator 220, the work tables 202 are guided along the support guides 210 via the table supports 208.

In some examples, the material removal tool 150 and table assembly 200 may work together to effect a deep cut to a workpiece secured across the air gap 250 between the two work tables 202. For example, the material removal tool 150 may be translated into alignment with the air gap 250 (e.g., via the linear actuator 128) and rotated (e.g., via the rotational actuator 124) down to a position where the material removal tool 150 extends below the work tables 202. Thereafter, the work tables 202 (and/or workpiece) may be moved toward the material removal tool 150 via the table actuator 220. Due to its alignment with the air gap 250, the movement of the work tables 202 may result in the material removal tool 150 being positioned in the air gap 250. By virtue of the depth of the air gap 250, the material removal tool 150 may effect a deep cut on the workpiece when the material removal tool 150 in the air gap 250 comes into contact with the portion of the workpiece extending across the air gap.

As another example, the material removal tool 150 may be translated into alignment with the air gap 250, but not rotated. Thereafter, the work tables 202 (and/or workpiece) may be moved toward the material removal tool 150 via the table actuator 220, such that the workpiece is positioned underneath the material removal tool 150. Once positioned below, the material removal tool 150 may be rotated downwards through the workpiece and air gap 250 to effect a deep “chop” cut.

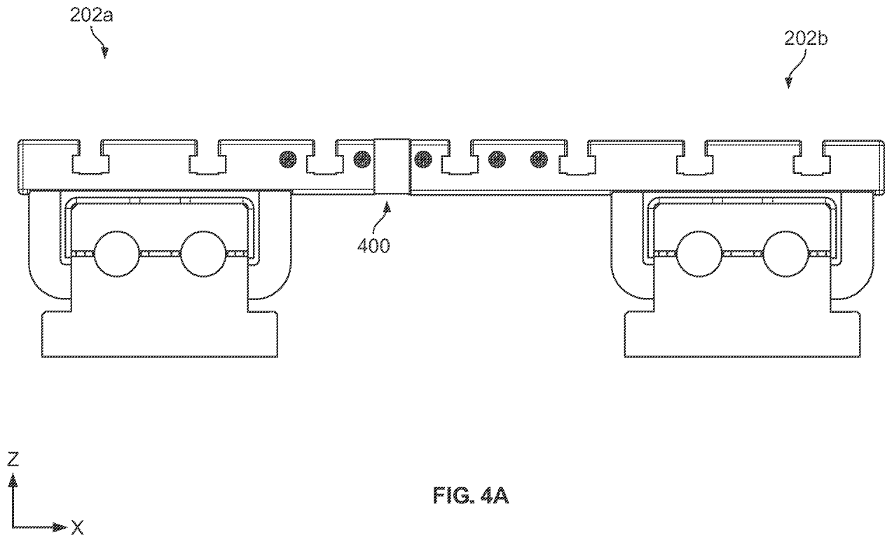

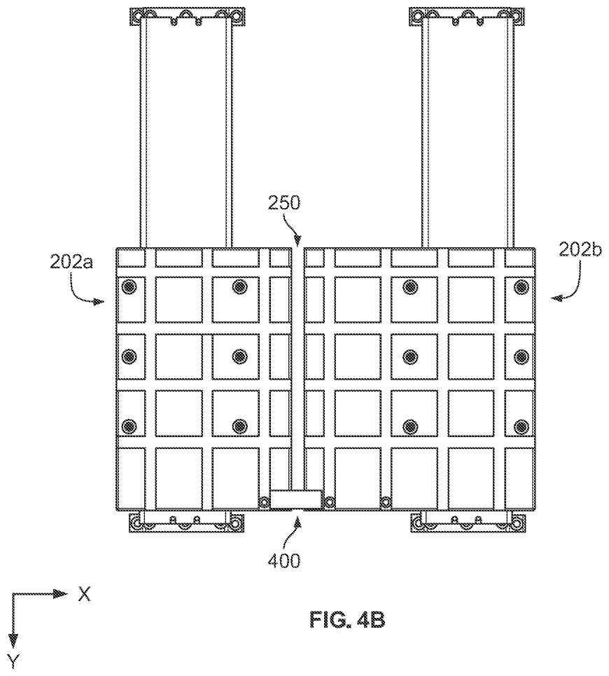

FIGS. 4a-4b show an example of alternative first and second work tables 202. As shown, a small connector piece 400 spans the air gap 250 and connects the work tables 202 at the front ends of the work tables 202. In some examples, such a design may eliminate the need for the actuator coupler 226 to connect to both work tables 202. Instead, the actuator coupler 226 may connect to only one work table 202 (and/or one table support 208), and rely on the connector piece 400 to carry the other work table 202 along. However, this design has the potential to put considerable stress and/or strain on the connector piece 400 during movement.

In some examples, a material removal machine 100 with work tables 202 separated by an air gap 250 may provide space for a material removal tool 150 of the material removal machine to extend between and substantially below the work tables 202 to effect a deep cut on a workpiece that extends across the air gap 250. Additionally, the table actuator 220 allows for the air gap 250 between the work tables 202 to be brought to the material removal machine 100, rather than vice versa, which allows for a more compact material removal machine 100 than if the material removal tool 150 itself were required to accommodate such movement. Furthermore, the efficient design of the table assembly 200 and cutting chamber 106 ensures both that the air gap 250 remains unobstructed to the floor 136 of the cutting chamber 106, and that the space between the work tables 202 and the floor 136 is sufficient for fluid/debris drainage and operator access.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor.

What is claimed is:

1. A material removal machine, comprising:
a material removal tool;
a tool support assembly retaining the material removal tool, the tool support assembly configured to translate the material removal tool along a first axis;
a first work surface;
a second work surface separated from the first work surface by an air gap;
a surface actuator configured to move the first work surface and second work surface along a second axis that is perpendicular to the first axis, such that the first work surface and second work surface can be moved to position the material removal tool in the air gap between the first work surface and second work surface when the material removal tool is aligned with the air gap;
a first surface support configured to support the first work surface; and
a second surface support configured to support the second work surface,
the air gap extending from a top of the first work surface or second work surface to a first bottom of the first surface support and a second bottom of the second surface support along a third axis that is perpendicular to the first axis and second axis, such that there is nothing obstructing the material removal tool from moving in the air gap between the first work surface and first surface support, and the second work surface and the second surface support.

2. The material removal machine of claim 1, wherein the material removal tool comprises a cutting, sectioning, or grinding disc.

3. The material removal machine of claim 1, wherein each of the first work surface and second work surface comprises a work table having a plurality of trenches configured to receive a vise that is configured to retain a sample.

4. The material removal machine of claim 1, further comprising a coupler connecting the surface actuator to the first work surface or second work surface, the surface actuator being configured to move the first work surface and second work surface via the coupler.

5. The material removal machine of claim 5, wherein the coupler connects to the first work surface and the second work surface.

6. The material removal machine of claim 1, wherein:
the first work surface comprises a first rear end, a first front end, and a first middle halfway between the first rear end and the first front end,
the second work surface comprises a second rear end, a second front end, and a second middle halfway between the second rear end and the second front end,
the second rear end, second front end, and second middle of the second work surface are approximately aligned with the first rear end, first front end, and first middle, respectively, of the first work surface, and
the second rear end and second middle of the second work surface is separated from the first rear end and first middle of the first work surface by the air gap.

7. The material removal machine of claim 1, further comprising:
a first support guide configured to guide the first work surface along the second axis when moved by the surface actuator, the first surface support coupling the first work surface to the first support guide; and
a second support guide configured to guide the second work surface along the second axis when moved by the surface actuator, the second surface support coupling the second work surface to the second support guide,
the air gap extending from the top of the first work surface or second work surface to a first support guide bottom of the first support guide and a second support guide bottom of the second support guide along a third axis.

8. The material removal machine of claim 7, wherein the first surface support comprises a first bearing assembly allowing the first surface support to move along the first support guide, and the second surface support comprises a second bearing assembly allowing the second surface support to move along the second support guide, the surface actuator being configured to move the first work surface, first surface support, second work surface, and second surface support.

9. The material removal machine of claim 1 further comprising a cabinet having a chamber that encloses the material removal tool, tool support assembly, first work surface, second work surface, surface actuator, first surface support, second surface support, and air gap.

10. The material removal machine of claim 9, wherein the first support and second support retain the first work surface and second work surface above a floor of the chamber, the air gap extending from the floor of the chamber to the top of the first work surface or second work surface along the third axis, such that there is nothing below the top of the first work surface or second surface obstructing the material removal tool from being positioned in the air gap.

11. A material removal machine, comprising:
a material removal tool;
a tool support assembly retaining the material removal tool, the tool support assembly configured to translate the material removal tool along a first axis;
a first work table;
a second work table separated from the first work table by an air gap;
a surface actuator configured to move the first work surface and second work surface along a second axis that is perpendicular to the first axis, such that the first work surface and second work surface can be moved to position the material removal tool in the air gap between the first work surface and second work surface when the material removal tool is aligned with the air gap; and
a support guide configured to guide movement of the first work surface or the second work surface along the second axis when moved by the table surface,
the air gap extending from a top of the first work surface or second work surface to a bottom of the support guide along a third axis that is perpendicular to the first axis and second axis, such that there is nothing obstructing the material removal tool from moving in the air gap between the first work surface and the second work surface.

12. The material removal machine of claim 11, wherein the material removal tool comprises a cutting, sectioning, or grinding disc.

13. The material removal machine of claim 11, wherein each of the first work surface and second work surface comprises a work table having a plurality of trenches configured to receive a vise that is configured to retain a sample.

14. The material removal machine of claim 11, further comprising a coupler connecting the surface actuator to the first work surface or second work surface, the surface actuator being configured to move the first work surface and second work surface via the coupler.

15. The material removal machine of claim 15, wherein the coupler connects to the first work surface and the second work surface.

16. The material removal machine of claim 11, wherein:
the first work surface comprises a first rear end, a first front end, and a first middle halfway between the first rear end and the first front end,
the second work surface comprises a second rear end, a second front end, and a second middle halfway between the second rear end and the second front end,
the second rear end, second front end, and second middle of the second work surface are approximately aligned with the first rear end, first front end, and first middle, respectively, of the first work surface, and
the second rear end and second middle of the second work surface is separated from the first rear end and first middle of the first work surface by the air gap.

17. The material removal machine of claim 11, wherein the support guide comprises a first support guide configured to guide movement of the first work surface along the second axis when moved by the surface actuator, the material removal machine further comprising:
a second support guide configured to guide movement of the second work surface along the second axis when moved by the surface actuator, the second surface support coupling the second work surface to the second support guide,
a first surface support configured to support the first work surface, the first surface support coupling the first work surface to the first support guide; and
a second surface support configured to support the second work surface, the second surface support coupling the second work surface to the second support guide,
the air gap extending from the top of the first work surface or second work surface to a first bottom of the first surface support and a second bottom of the second surface support along the third axis.

18. The material removal machine of claim 17, wherein the first surface support comprises a first bearing assembly allowing the first surface support to move along the first support guide, and the second surface support comprises a second bearing assembly allowing the second surface support to move along the second support guide, the surface actuator being configured to move the first work surface, first surface support, second work surface, and second surface support.

19. The material removal machine of claim 11, further comprising a cabinet having a chamber that encloses the material removal tool, tool support assembly, first work surface, second work surface, surface actuator, support guide, and air gap.

20. The material removal machine of claim 19, wherein the first work surface and second work surface are retained above a floor of the chamber, the air gap extending from the floor of the chamber to the top of the first work surface or second work surface along the third axis, such that there is nothing below the top of the first work surface or second surface obstructing the material removal tool from being positioned in the air gap.
